(19) United States
(12) Patent Application Publication
(10) Pub. No.: US 2012/0198076 A1
(43) Pub. Date: Aug. 2, 2012

(54) Migrating Logical Partitions

(75) Inventors: Srinivas Kancharla, Bangalore (IN); Mallesh Lepakshaiah, Bangalore (IN); Anbazhagan Mani, Bangalore (IN); Uday Medisetty, Bangalore (IN)

(73) Assignee: INTERNATIONAL BUSINESS MACHINES CORPORATION, Armonk, NY (US)

(21) Appl. No.: 13/431,394

(22) Filed: Mar. 27, 2012

Related U.S. Application Data
(63) Continuation of application No. 12/625,852, filed on Nov. 25, 2009.

(51) Int. Cl. G06F 15/173

(52) U.S. Cl. 709/226

(57) ABSTRACT

Methods for migrating logical partitions. The method may include dynamically discovering a destination system for migration; remotely creating an environment on the destination system for accepting the runtime migration; and migrating a running logical partition from a source system to the destination system. The source system may be managed by a source management system and the destination system may be managed by a destination management system. Dynamically discovering the destination system for migration may comprise establishing a communications channel between the source management system and the destination management system; obtaining a list of candidate systems from the destination management system; and validating resources of at least one candidate system.

### PRIORITY

This application is a continuation of U.S. patent application Ser. No. 12/625,852 filed Nov. 25, 2009.

### BACKGROUND

Modern computing typically relies on applications running in a computing environment of an operating system (‘OS’). The OS acts as a host for computing applications. The OS is responsible for the management and coordination of activities and the sharing of the resources of the computer. Techniques for allowing multiple OSs to run on a host computer concurrently have increased efficiency by decreasing the number of required machines. One technique for allowing multiple OSs to run on a host computer involves the use of logical partitions, in which a portion of a host's resources are virtualized as a separate computer so that many logical partitions co-exist on a particular system. The logical partition may include either dedicated or shared processors. As a virtualized computer, the logical partition may be migrated to another physical host computer. Migration may be performed, for example, to modify system architecture in response to changing technical requirements.

### SUMMARY

Methods for migrating logical partitions are disclosed herein. In one general embodiment, a method includes dynamically discovering a destination system for migration; remotely creating an environment on the destination system for accepting the runtime migration; and migrating a running logical partition from a source system to the destination system. The source system may be managed by a source management system and the destination system may be managed by a destination management system. In another general embodiment, a method includes dynamically discovering a destination system for migration; and migrating a running logical partition from a source system to the destination system. Dynamically discovering the destination system for migration may comprise establishing a communications channel between the source management system and the destination management system; obtaining a list of candidate systems from the destination management system; and validating resources of at least one candidate system.

The foregoing and other objects, features and advantages of the disclosure will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a flow chart illustrating a method for migrating logical partitions according to embodiments of the present invention.

FIGS. 2A and 2B set forth block diagrams of example computers in accordance with embodiments of the invention.

FIGS. 3A and 3B are data flow diagrams illustrating methods for migrating logical partitions in accordance with embodiments of the invention.

FIG. 4 is a data flow diagram illustrating methods for migrating logical partitions in accordance with embodiments of the invention.

FIGS. 5A-5C set forth a block diagram illustrating system states in accordance with embodiments of the invention.

### DETAILED DESCRIPTION

Exemplary methods for migrating local partitions are described with reference to the accompanying drawings. The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, components, acts, and equivalents of all means or step plus function elements in the claims below are intended to include any structure, material or act for performing the function in combination with other claimed elements as specifically claimed. The description of various embodiments of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

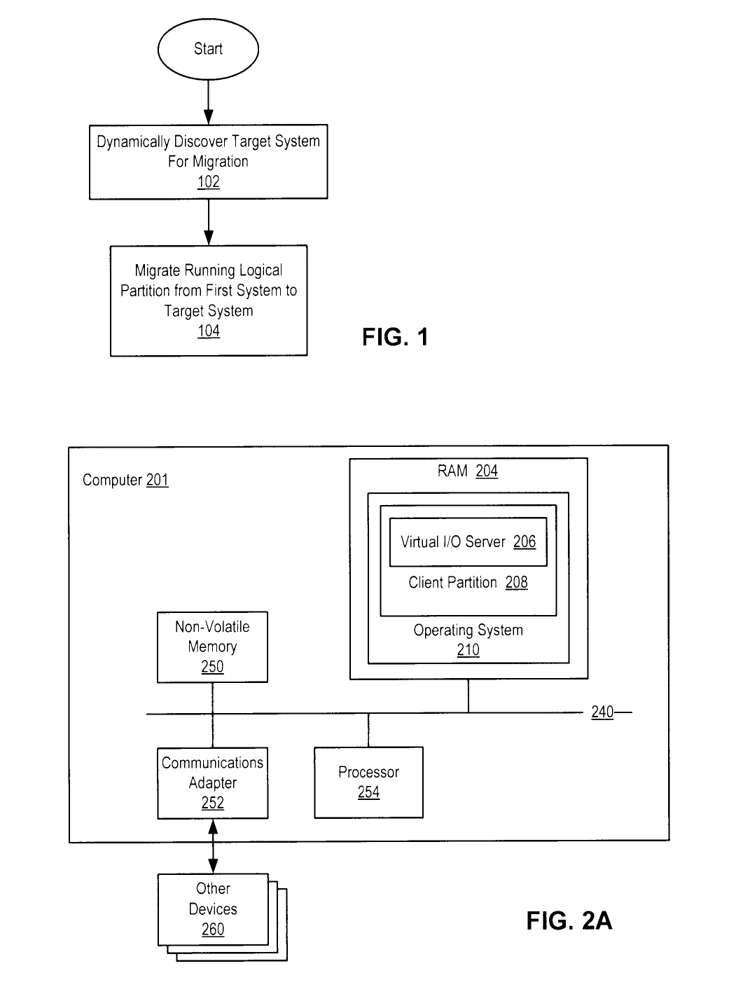

FIG. 1 sets forth a flow chart illustrating a method for migrating logical partitions according to embodiments of the present invention. Migrating a logical partition to a new logical partition may only be carried out successfully if sufficient resources are available for the new logical partition on a new host data processing system (‘destination system’). A common environment for logical partitions is a datacenter. Datacenters may include dozens or hundreds of data processing systems. Hundreds of logical partitions on large numbers (e.g., 12, 48, 64, etc.) of data processing systems may be controlled by a single management system, such as a hardware management console (‘HMC’). Confirming sufficient resources such as computing capacity, memory, and input/output resources for logical partition migration can be inefficient.

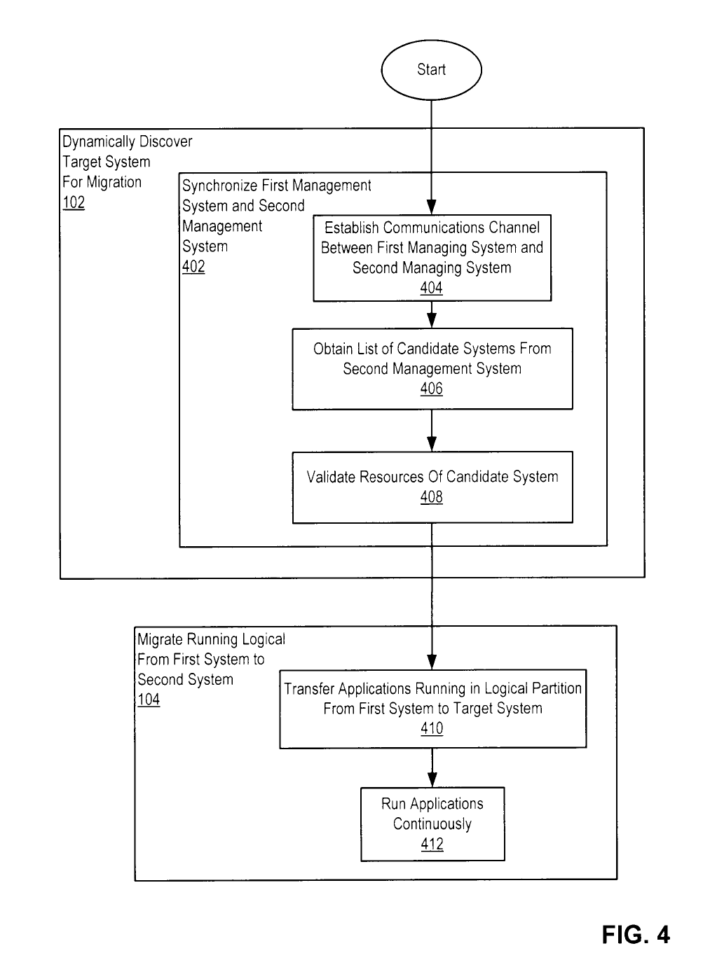

Referring to FIG. 1, the method includes dynamically discovering a destination system for migration (block 102); and migrating a running logical partition from a source system to the destination system (block 104). Dynamically discovering a destination system for migration (block 102) may be carried out over a range of network addresses, e.g., Internet Protocol (‘IP”) addresses. Thus, dynamically discovering a destination system for migration (block 102) may operate on large groups of systems, all the systems in a data center, or subsets of a datacenter, as will occur to those of skill in the art. Migrating a running logical partition from a source system to the destination system (block 104) may be carried out by replicating memory pages from the source system to the destination system in a way that is transparent to the operating system and applications running in the partition, as discussed further with reference to FIG. 4.

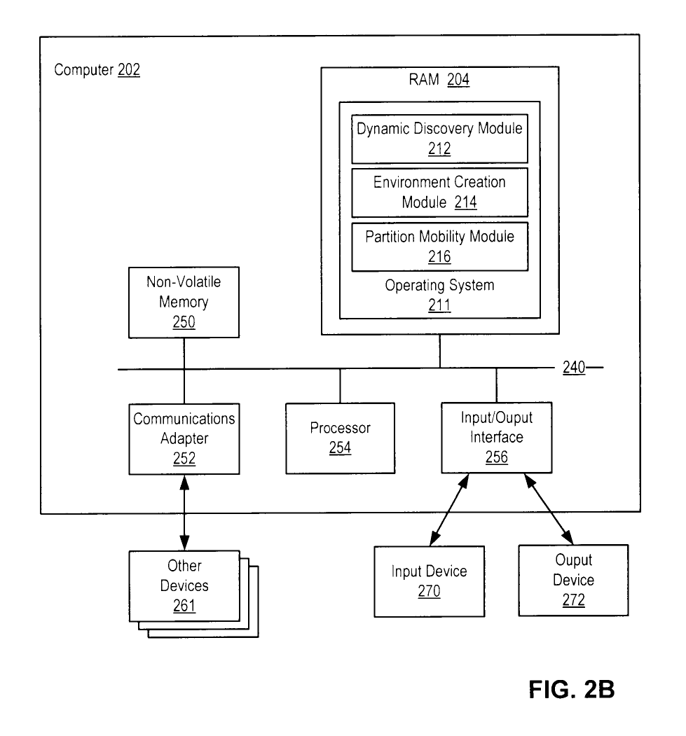

Embodiments of the presently disclosed invention are implemented to some extent as software modules installed and running on one or more data processing systems (‘computers’), such as servers, workstations, PCs, mainframes, and the like. FIGS. 2A and 2B set forth a block diagram of computers 201 and 202. FIG. 2A sets forth a data processing system 201 used for hosting logical partitions. FIG. 2B sets forth a management system 202. Management system 202 may create and manage local partitions, dynamically reallocate resources, facilitate hardware control, and so on. Computers 201, 202 each include at least one computer processor 254 as well as a computer memory, including both volatile random access memory (‘RAM’) 204 and some form or forms of non-volatile computer memory 250 such as a hard disk drive, an optical disk drive, or an electrically erasable programmable read-only memory space (also known as ‘EEPROM’ or ‘Flash’ memory). The computer memory may be connected through a system bus 240 to the processor 254 and to other system components. Thus, the software modules may be program instructions stored in computer memory.

An operating system 210 is stored in the computer memory of computer 201. Computer 201 may have more than one operating system or more than one instance of the same operating system running. An operating system 211 is stored in the computer memory of computer 202. Operating systems 210, 211 may be any appropriate operating system such as Windows XP, Windows Vista, Microsoft Server, Mac OS X, UNIX, LINUX, Sun Microsystems's Solaris, AIX from International Business Machines Corporation (Armonk, N.Y.). Operating system 211 may also be Hardware Management Console software from International Business Machines Corporation (Armonk, N.Y.).

Computer 202 may also include one or more input/output interface adapters 256. Input/output interface adapters 256 may implement user-oriented input/output through software drivers and computer hardware for controlling output to output devices 272 such as computer display screens, as well as user input from input devices 270, such as keyboards and mice.

Computer 201 may also include a communications adapter 252 for implementing data communications with other devices 260. Computer 202 may also include a communications adapter 252 for implementing data communications with other devices 261. Communications adapter 252 implements the hardware level of data communications through which one computer sends data communications to another computer through a network.

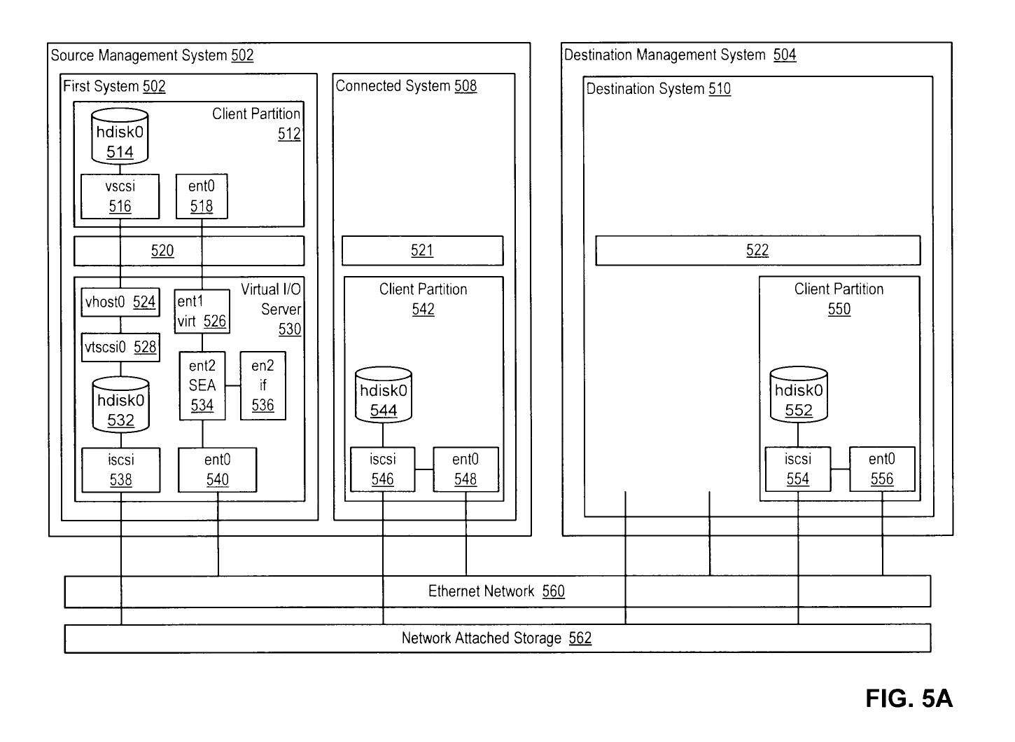

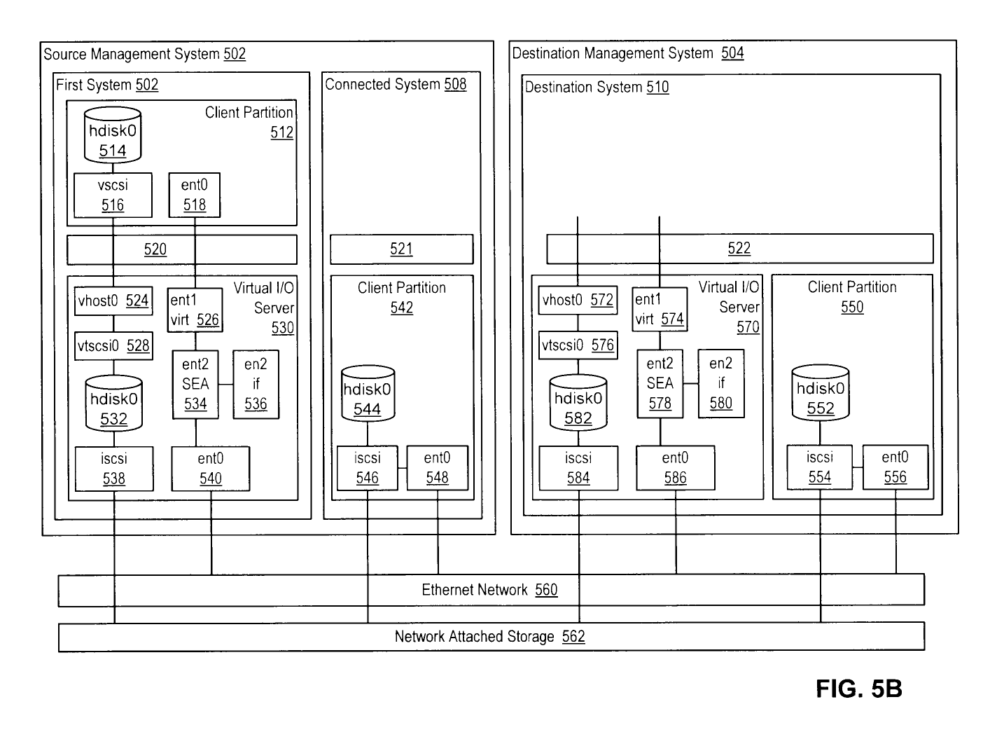

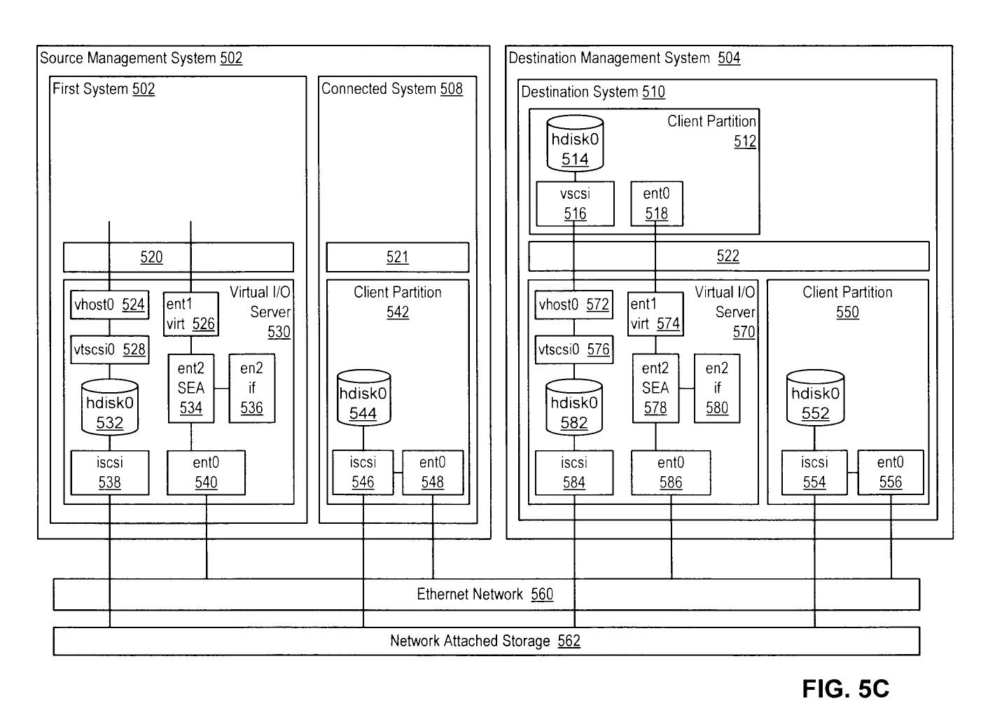

Modules stored in computer memory are different in computer 201 than in computer 202. In computer 201, also stored in computer memory is a logical partition module 206. Logical partition module 208 includes computer readable program instructions that enable logical partition functionality. Also stored in memory in computer 201 a hypervisor 215. Hypervisor 215 comprises partition management software for controlling the host processor and other resources and allocating resources to each partition on the system. Computer 201 may contain more than one partition. Computer 201 may also contain different various special-purpose software modules over time, described in greater detail with reference to FIG. 5A-C.

Also stored in computer memory is virtual I/O server 206. Virtual I/O server 206 may be located in a logical partition instance. Virtual I/O server 206 facilitates the sharing of physical I/O resources between client logical partitions within the computer. Virtual I/O server 206 provides virtual Small Computer System Interface (‘SCSI’) target, virtual fibre channel, and Shared Ethernet Adapter (‘SEA’) capability to client logical partitions within the system. As a result, client logical partitions can share SCSI devices, fibre channel adapters, Ethernet adapters, and expand the amount of memory available to logical partitions using paging space devices.

Computer 202 also has stored in computer memory dynamic discovery module 212. Dynamic discovery module 212 may include computer readable program instructions configured to dynamically discover a destination system for migration. Computer 202 also has stored in computer memory environment creation module 214. Environment creation module 214 may include computer readable program instructions configured to remotely create an environment on the destination system for accepting a runtime migration. Computer 202 also has stored in computer memory partition mobility module 216. Partition mobility module 216 may include computer readable program instructions configured to migrate a running logical partition from a source system to the destination system.

The dynamic discovery module 212, environment creation module 214, and partition mobility module 216 may be incorporated in operating system 211. The modules 212-216 may be implemented as one or more sub-modules operating in separate software layers or in the same layer. Although depicted as being incorporated into the operating system 211 in FIG. 2B, the modules 212-216 or one or more sub-modules making up one or more of the modules 212-216 may be separate from the operating system 211. In some embodiments, virtual I/O server 208, dynamic discovery module 212, environment creation module 214, and/or partition mobility module 216 may be implemented in the software stack, in hardware, in firmware (such as in the BIOS), or in any other manner as will occur to those of ordinary skill in the art.

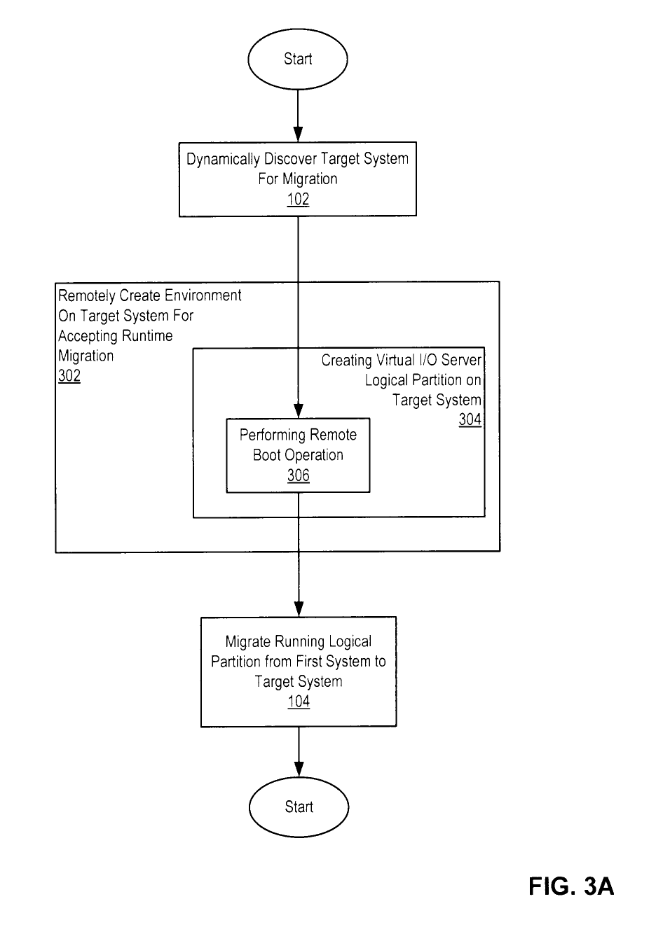

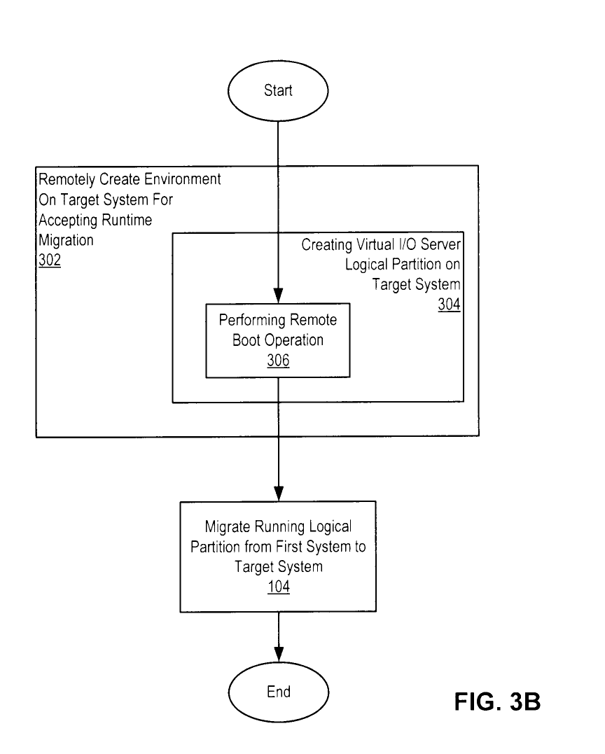

FIG. 3 is a data flow diagram illustrating a method for migrating logical partitions in accordance with embodiments of the invention. The method includes dynamically discovering a destination system for migration (block 102) and migrating the running logical partition from the source system to the destination system (block 104), as discussed above. Additionally, upon discovering the destination system, the environment creation module 114 remotely creates an environment on the destination system for accepting the runtime migration (block 302).

Creating an environment on the destination system for accepting the runtime migration (block 302) may include creating a virtual input/output server logical partition on the destination system (block 304). Creating a virtual input/output server logical partition on the destination system (block 304) may be carried out by performing a remote boot operation. The remote boot operation may be performed with iSCSI, Etherboot, Intel's Preboot eXecution Environment (‘PXE’), or any other diskless booting technique as will occur to those of skill in the art. Performing a remote boot may be carried out employing a small option ROM image, which contains iSCSI client code, a TCP/IP stack, and BIOS interrupt code. Upon boot, the BIOS disk I/O interrupt goes through the boot code to communicate directly with the remote iSCSI target, providing seamless access to the SCSI files.

FIG. 3B sets forth a data flow diagram illustrating a method for migrating logical partitions in accordance with another embodiment of the invention. Referring to FIG. 3B, the method comprises creating an environment on the destination system for accepting the runtime migration (block 302) and migrating the running logical partition from the source system to the destination system (block 104). The method of FIG. 3B is carried out similarly to FIG. 3A, but forgoes dynamically discovering a destination system for migration (block 102), which may be carried out separately, or which be left unused if a destination system is previously known.

FIG. 4 sets forth a data flow diagram illustrating a method for migrating logical partitions in accordance with embodiments of the invention. In the method of FIG. 4, the source system is managed by a source management system and the destination system is managed by a destination management system, so that the source system and the destination system are on separate networks. Referring to FIG. 4, the method further includes dynamically discovering a destination system for migration (block 102) and migrating the running logical partition from the source system to the destination system (block 104). Dynamically discovering the destination system for migration (block 102) may include synchronizing the source management system and the destination management system (block 402).

Synchronizing the source management system and the destination management system (block 402) establishing a communications channel between the first management system and the destination management system (block 404). Establishing a communications channel between the first management system and the destination management system (block 404) may be carried out by source management system sending, for example, an HMC identification daemon for handshaking via the Internet Protocol Suite (‘TCP/IP’). The HMC identification daemon will respond to the HMC id daemon which is running on management systems within the network. Through these acknowledgements, a source management system identifies all the management systems which can host the partition which will be migrated.

Synchronizing the source management system and the destination management system (block 402) may also include obtaining a list of candidate systems from the destination management system (block 406); and validating resources of at least one candidate system (block 408). Obtaining a list of candidate systems from the destination management system (block 406) may be carried out by ascertaining the availability of systems under each management system and each system's available resources. The candidate list may be generated by invoking a “lssysconn” command, which lists connection information for all of the systems and frames managed by the source management system 502. The linked managed system lists connection information for all systems and frames to which the linked system is connected or attempting to connect.

Validating resources of at least one candidate system (block 408) may be carried out dynamically from the latest system properties. The dynamic discovery module 212 compares the source partition profile resources with candidate systems to find a match having enough resources to launch the migrated partition. The “lsshwres” command lists the hardware resources of the candidate system, including physical I/O, virtual I/O, memory, processing, host channel adapter (‘HCA’), and switch network interface (‘SNI’) adapter resources. If the exact requested resources are not found in a candidate system, the dynamic discovery module 212 module may employ criteria to determine the most likely fit. After resource validation, the source management system will start communicating with the destination management system and the destination system to deploy the necessary partition environment.

Information about resources assigned to a partition is stored in a partition profile. Each partition may have multiple partition profiles. A partition profile may include information about resources such as processor, memory, physical I/O devices, and virtual I/O devices (e.g., Ethernet, serial, and SCSI). Each partition must have a unique name and at least one partition profile.

Migrating the running logical partition from the source system to the destination system (block 104) may include transferring applications running in the logical partition prior to migration from the source system to the destination system (410) and running the applications continuously (block 412). Transferring applications running in the logical partition prior to migration from the source system to the destination system (410) and running applications continuously (block 412) may be carried out by employing checkpointing to move the running partitions. The checkpoint saves and validates the status of current applications and then restarts the application in the new partition in this saved state.

Migrating a running logical partition from a source system to the destination system (block 104) may include invoking the “mksyscfg” command. This command may be used to create/define the partition environment, and the profile, to meet requested resources for the migrating partition. Resource selection/allocation may be determined from the log profile for the source partition, which the source management system generates at the time of validation. In the process of creating the destination partition, the system names the profile, for example by adding the serial number of the first system. With this serial number, the destination system can identify the first system's information. The “mksyscfg” command creates partitions, partition profiles, or system profiles for managed systems.

One or more of dynamic discovery module 212, environment creation module 214, and partition mobility module 216 maintains a log in the source management system and the destination management system containing the profile information history of the source client partition and the destination client partition for identifying both the destination client partition from the source management system and source information from the destination management system.

FIGS. 5A-5C set forth a block diagram illustrating system states according to embodiments of the present disclosure. FIG. 5A illustrates system states in a discovery phase of the present disclosure. Referring to FIG. 5A, a first network includes a source management system 502 managing a source system 506 and a connected system 508. Source management system 502 is depicted as containing source system 506 and connected system 508 to illustrate that source management system 502 manages both systems in its private network.

The source system 506 includes a client partition 512 running on it. Connected system 508 and destination system 510 have client partition 542 and client partition 550, respectively, running on them. The source system 506, the connected system 508, and the destination system 510 each contain a hypervisor 520, 521, 522, a partition manager controlling the host processor and other resources and allocating resources to each partition on the system. An operating system instance inside a logical partition calls the hypervisor in place of its traditional direct access to the hardware and address-mapping facilities.

The client partition 512 is a logical partition containing logical hard disk hdisk0 514. Logical hard disk hdisk0 514 is connected to a virtualized implementation of the SCSI protocol (vscsi 516), i.e., a virtual SCSI device. Client partition 512 accesses virtualized storage devices through vscsi 516. The virtual device vscsi 516 is accessed as one or more standard SCSI-compliant logical unit numbers (‘LUNs’) by the client partition. A LUN is the identifier of an iSCSI logical unit. A logical unit is a SCSI protocol entity that performs storage operations (e.g., read and write). Each SCSI target provides one or more logical units. A logical unit is represented within a computer operating system as a device.

A network device ent0 518 in the client partition 512 is an implementation of a logical Host Ethernet Adapter (‘LHEA’) for the client partition 512. The network device ent0 518 enables TCP/IP configuration similar to a physical Ethernet device for communicating with other logical partitions. An LHEA is a representation of a physical Host Ethernet Adapter (‘HEA’) on a logical partition. An LHEA appears to the operating system as if it were a physical Ethernet adapter. As it is typically not possible to assign an HEA to a logical partition directly, connecting a logical partition to an HEA is implemented through an LHEA in the logical partition. An LHEA for a logical partition enables multiple logical partitions to connect directly to the HEA and use the HEA resources. This allows these logical partitions to access external networks through the HEA while avoiding an Ethernet bridge on another logical partition.

The source system 506 includes a virtual I/O server 530 to facilitate communications for the client partition 512. Virtual I/O server 530 includes a virtual host vhost0 524 and a virtual target device vtscsi0 528. To make a physical disk available to a client partition 512, the client partition 512 is assigned to a virtual SCSI server adapter in the virtual I/O server 530 represented by vhost0 524.

The client partition 512 accesses its assigned disks through a virtual SCSI client adapter. The virtual SCSI client adapter sees the disks through this virtual adapter as virtual SCSI disk devices. The virtual target device vtscsi0 528 is available after mapping the physical disks with virtual host. This is the target device which will communicate to client partition 512. The Internet Small Computer System Interface (‘iSCSI’) adapter iscsi 538 uses the Internet Protocol Suite (TCP/IP) to allow the source system to negotiate and then exchange SCSI commands using IP networks to implement storage with network attached storage 562.

Virtual I/O server 206 further includes virtual Ethernet adapater 526, shared Ethernet adapter 534, Ethernet interface 536 and Ethernet adaptor 540 which provide Shared Ethernet Adapter (‘SEA’) capability to client logical partitions within the system. As a result, client logical partitions can share SCSI devices, fibre channel adapters, connection to Ethernet 560, and expand the amount of memory available to logical partitions using paging space devices.

In this example, connected system 508 lacks the resources for a migration of client partition 512 from source system 506. Since the private network for source management system 502 lacks a candidate system with sufficient resources, the source management system 502 communicates with available management systems within a connected general network (e.g., a datacenter LAN, the Internet, etc.), obtains candidates, and verifies that the candidates have appropriate resources for the migration of client partition 512.

Client partition 542 on connected system 508 uses Ethernet adapter 548 and iSCSI adapter 546 to provide communications and provide logical disk hdisk 544. Client partition 550 on destination system 510 uses Ethernet adapters 556 and iSCSI adapter 554 to provide communications and provide logical disk hdisk 552.

In a second private network, a destination management system 504 manages destination system 510. Destination system 510 has available memory space, processing capacity, and logical partition instances appropriate for accepting the migration. Source management system 502 and destination management system 504 are connected through a general Internet Protocol (‘IP’) network. The source management system 502 discovers destination system 510 as a candidate and selects system 510 as the destination system.

Although FIG. 5B depicts each managed system as including reserved Ethernet/iSCSI adapters, in some implementations, no Ethernet/iSCSI adapters have been reserved. In that case, any free adapters will be used. FIG. 5B illustrates system states in an environment creation phase of the present disclosure. A virtual I/O server is needed for migration. Since destination system 510 lacks a virtual I/O server, the managed system 502, 504 create virtual I/O server 570 on the destination system 510 in the environment creation phase. Virtual I/O server 570 is functionally identical to virtual I/O server 530. The source management system 502 communicates with the other management systems on the network using secure shell (‘SSH’), a network protocol for establishing a secure channel. Management systems 502 and 504 maintain a pool of virtual I/O server rootvg LUNs on the Network Attached Storage (‘NAS’) 562. All of the reserved iSCSI adapters are configured and are assigned to LUNs which have virtual I/O server rootvg images on the NAS 562. If no Ethernet/iSCSI adapters have been reserved, management systems 502, 504 dynamically determine Ethernet adapter details and create a mapping using initiator IDs.

Virtual I/O server 570 is created on demand using the software command “mksyscfg.” Once a connection between the source management system 502 and the destination management system 504 is established, source management system 502 calls a procedure which creates virtual I/O server 570 on management system 504. The systems assign reserved Ethernet/iSCSI adapters to virtual I/O server 570 and create the virtual I/O server partition profile from source management system 502. The environment creation module 214 boots virtual I/O server 570 from one of the LUN's in the virtual I/O server rootvg images pool via an iSCSI boot. Referring to FIG. 5C, after environment creation, the management systems 502, 504 migrate client partition 512 to destination system 510.

It should be understood that the inventive concepts disclosed herein are capable of many modifications. To the extent such modifications fall within the scope of the appended claims and their equivalents, they are intended to be covered by this patent.

What is claimed is:

1. A computer-implemented method for migrating logical partitions, the method comprising:
dynamically discovering a destination system for migration;
remotely creating an environment on the destination system for accepting the runtime migration by creating a virtual input/output server logical partition on the destination system; and
migrating a running logical partition from the source system to the destination system.

2. The method of claim 1 wherein creating the virtual input/output server logical partition on the destination system comprises performing a remote boot operation.

3. The method of claim 1 wherein the source system is managed by a source management system and the destination system is managed by a destination management system.

4. The method of claim 3 wherein dynamically discovering the destination system for migration comprises:
establishing a communications channel between the source management system and the destination management system;
obtaining a list of candidate systems from the destination management system; and
validating resources of at least one candidate system.

5. The method of claim 3 further comprising synchronizing the source management system and the destination management system.
